(19) United States
(12) Patent Application Publication
(10) Pub. No.: US 2025/0087752 A1
(43) Pub. Date: Mar. 13, 2025

(54) NON-AQUEOUS ELECTROLYTES AND SECONDARY BATTERIES COMPRISING THE SAME

(71) Applicant: Apple Inc., Cupertino, CA (US)

(72) Inventors: Jongho Jeon, San Jose, CA (US); Qian Liu, Darien, IL (US); Hongli Dai, Los Altos, CA (US); Zhengchang Zhang, Naperville, IL (US); James A. Gilbert, Bolingbrook, IL (US)

(21) Appl. No.: 18/812,895

(22) Filed: Aug. 22, 2024

Related U.S. Application Data
(60) Provisional application No. 63/581,569, filed on Sep. 8, 2023.

(51) Int. Cl. H01M 10/0568; H01M 10/0525; H01M 10/0567; H01M 10/0569

(52) U.S. Cl. CPC H01M 10/0568; H01M 10/0525; H01M 10/0567; H01M 10/0569; H01M 2300/0042

(57) ABSTRACT

This disclosure relates generally to battery cells, and more particularly, electrolyte additives for use in lithium ion battery cells.

### PRIORITY

This patent application claims the benefit of U.S. Provisional Patent Application No. 63/581,569, entitled “NON-AQUEOUS ELECTROLYTES AND SECONDARY BATTERIES COMPRISING THE SAME,” filed on Sep. 8, 2023, which is incorporated herein by reference in its entirety.

### U.S. GOVERNMENT LICENSE RIGHTS

This invention was made with U.S. government support under WFO Proposal No. 85C85 T0 0006. This invention was made under a CRADA 1500801 between Apple Inc. and Argonne National Laboratory operated for the United States Department of Energy. The U.S. government has certain rights in the invention.

### FIELD

This disclosure relates generally to battery cells, and more particularly, electrolyte additives for use in lithium ion battery cells.

### BACKGROUND

Li-ion batteries are widely used as the power sources in consumer electronics. Consumer electronics need Li-ion batteries which can deliver higher volumetric energy densities and sustain more discharge-charge cycles.

A battery life cycle can deteriorate due to instability of cathode structure and electrolyte degradation. The cathode material stability can be improved by the modification of LiCoO₂ such as doping and surface coating. Limited progress has been made in developing electrolytes that can enable both high energy retention and low internal resistance, thereby resulting in long battery cycling life.

### SUMMARY

In a first aspect, the disclosure is directed to an electrolyte fluid comprising a lithium bis(fluoromethanesulfonyl)imide selected from lithium bis(trifluoromethanesulfonyl)imide (LiTFSI), lithium bis(difluoromethanesulfonyl)imide (LiDFSI), lithium bis(monofluoromethanesulfonyl)imide (LiMFSI). In some variations, the lithium bis(fluoromethanesulfonyl)imide is in an amount of 0.05 wt %-3.0 wt % of the electrolyte fluid.

In a second aspect, the electrolyte fluid includes LiBF₄.

In a third aspect, the electrolyte fluid includes a salt selected from LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof.

In a fourth aspect, the electrolyte fluid includes an additive selected from fluoroethylene carbonate (FEC), methylene methanedisulfonate (MMDS), pro-1-ene-1,3-sultone (PES), propane sultone (PS), lithium difluoro (oxalato) borate (LiDFOB), succinonitrile (SN), 1,3,6-hexanetricarbonitrile (HTCN), and a combination thereof.

In a fifth aspect, the electrolyte fluid can include an electrolyte salt selected from LiPF₆, LiBF₄, LiClO₄, LiSO₃CF₃, LiN(SO₂F)₂, LiN(SO₂CF₃)₂, LiBC₄O₈, Li[PF₃ (C₂CF₅)₃], LiC(SO₂CF₃)₃, and a combination thereof. In some variations, the salt is LiPF₆.

In a seventh aspect, the electrolyte fluid can include a solvent selected from propylene carbonate (PC), ethylene carbonate (EC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), butyl acetate (BA), and a combination thereof. In some variations, the solvent is selected from PC, EC, PP, EP, and a combination thereof. In some variations, the solvent comprises PC, EC, PP, and EP.

In a sixth aspect, the disclosure is directed to a battery cell. The battery cell can include a cathode having a cathode active material disposed on a cathode current collector, and an anode having an anode active material disposed on an anode current collector. The anode is oriented towards the cathode such that the anode active material faces the cathode active material. A separator is disposed between the cathode active material and the anode active material. An electrolyte fluid as described herein is disposed between the cathode and anode.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell, in accordance with an illustrative embodiment;

FIG. 2 is a perspective view of a battery cell, in accordance with an illustrative embodiment;

FIG. 3A depicts a cyclic voltammogram of Electrolyte Fluid 1 without LiTFSI, in accordance with illustrative embodiments;

FIG. 3B depicts a cyclic voltammogram of Electrolyte Fluid 1 with 0.3 wt % LiTFSI, in accordance with illustrative embodiments;

FIG. 4A depicts the energy retention as a function of cycle count for battery cells in a multi-layer pouch (MLP) containing Electrolyte Fluids 1, 2, or 3 at 45° C., in accordance with illustrative embodiments; and

FIG. 4B depicts the internal resistance as a function of cycle count for battery cells in an MLP containing Electrolyte Fluids 1, 2, or 3 at 45° C., in accordance with illustrative embodiments.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The disclosure is directed to electrolyte fluids that include a lithium bis(fluoromethanesulfonyl)imide. The lithium bis(fluoromethanesulfonyl)imide can be one or more of lithium bis(trifluoromethanesulfonyl)imide (LiTFSI), lithium bis(difluoromethanesulfonyl)imide (LiDFSI), and lithium bis(monofluoromethanesulfonyl)imide (LiMFSI).

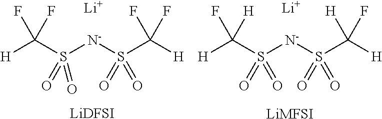

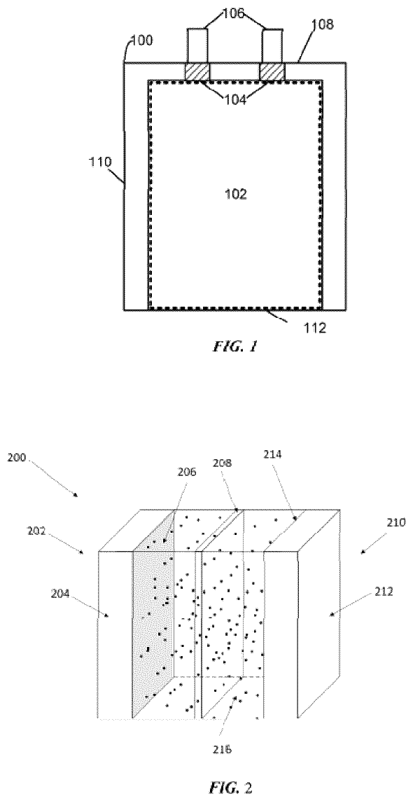

FIG. 1 presents a top-down view of a battery cell 100 in accordance with an illustrative embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode with a cathode active coating, a separator, and an anode with an anode active coating. More specifically, the stack 102 may include one strip of cathode active material (e.g., aluminum foil coated with a lithium compound) and one strip of anode active material (e.g., copper foil coated with carbon). The stack 102 also includes one strip of separator material (e.g., a microporous polymer membrane or non-woven fabric mat) disposed between the one strip of cathode active material and the one strip of anode active material. The cathode, anode, and separator layers may be left flat in a planar configuration or may be wrapped into a wound configuration (e.g., a “jelly roll”). An electrolyte solution is disposed between each cathode and anode.

During assembly of the battery cell 100, the stack 102 can be enclosed in a pouch or container. The stack 102 may be in a planar or wound configuration, although other configurations are possible. In some variations, the pouch such as a pouch formed by folding a flexible sheet along a fold line 112. In some instances, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack or may be embedded within an enclosure of a portable electronic device, such as a laptop computer, tablet computer, mobile phone, personal digital assistant (PDA), digital camera, and/or portable media player.

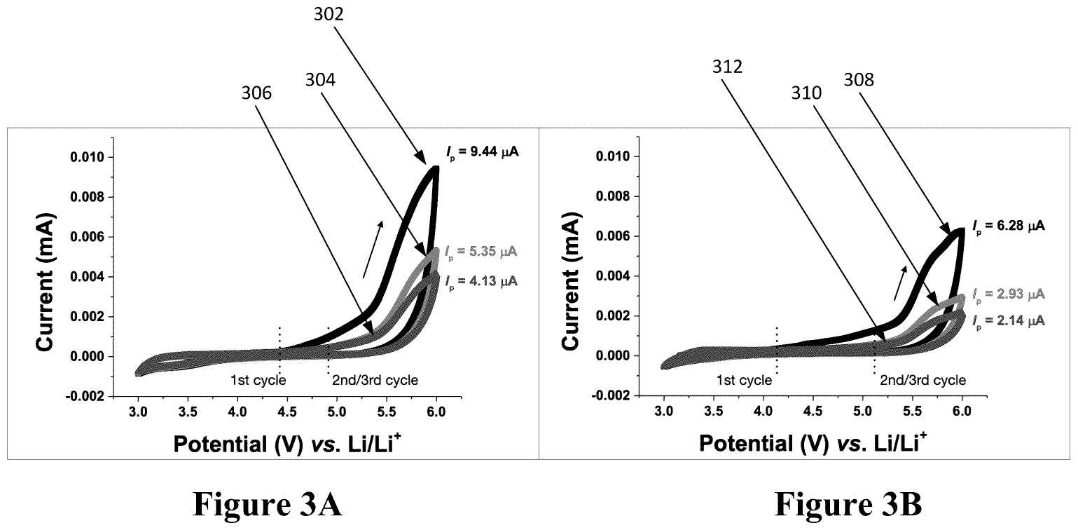

FIG. 2 presents a perspective view of battery cell 200 (e.g., the battery cell 100 of FIG. 1) in accordance with the disclosed illustrative embodiments. The battery includes a cathode 202 that includes current collector 204 and cathode active material 206 and anode 210 including anode current collector 212 and anode active material 214. Separator 208 is disposed between cathode 202 and anode 210. Electrolyte fluid 216 is disposed between cathode 202 and anode 210, and is in contact with separator 208. To create the battery cell, cathode 202, separator 208, and anode 210 may be stacked in a planar configuration, or stacked and then wrapped into a wound configuration. The Electrolyte fluid 216 can then be added. Before assembly of the battery cell, the set of layers may correspond to a cell stack.

The cathode current collector, cathode active material, anode current collector, anode active material, and separator may be any material known in the art. In some variations, the cathode current collector may be an aluminum foil, the anode current collector may be a copper foil. The cathode active material can be any material described in, for example, Ser. No. 14/206,654, 15/458,604, 15/458,612, 15/709,961, 15/710,540, 15/804,186, 16/531,883, 16/529,545, 16/999,307, 16/999,328, 16/999,265, each of which is incorporated herein by reference in its entirety.

The separator may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (Pad). However, other microporous polymer membranes or non-woven fabric mats are possible (e.g., gel polymer electrolytes).

In general, separators represent structures in a battery, such as interposed layers, that prevent physical contact of cathodes and anodes while allowing ions to transport therebetween. Separators are formed of materials having pores that provide channels for ion transport, which may include absorbing an electrolyte fluid that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

In general, electrolyte fluid can act a conductive pathway for the movement of cations passing from the negative to the positive electrodes during discharge. The electrolyte fluid includes an electrolyte salt, a solvent, and one or more electrolyte additives.

As disclosed herein, the electrolyte fluid includes a bis(fluoromethanesulfonyl) imide. In some variations, the electrolyte fluid includes LiTFSI. In some variations, the electrolyte fluid includes LiDFSI. In some variations, the electrolyte fluid includes LiMFSI. In some combinations, the electrolyte fluid can include more than one of LiTFSI, LiDFSI, and LiMFSI.

In some variations, the electrolyte fluids further includes lithium tetrafluoroborane (LiBF₄).

Components of the electrolyte fluids, including the bis(fluoromethanesulfonyl) imide (e.g., LiTFSI, LiDFSI, and LiMFSI, combinations thereof, and degradation products thereof), provide a passivation layer at the cathode active material. The passivation layer results in lower cathode active material degradation. Battery cells that include the electrolyte fluids described herein can have improved energy retention, lower internal resistance (RSS), and/or reduced battery swelling at high temperature, including during high voltage operation.

In some variations, the bis(fluoromethanesulfonyl) imide is in an amount of 0.05 wt %-3.0 wt % of the electrolyte fluid. In some variations, the bis(fluoromethanesulfonyl) imide can be at least 0.05 wt % of the electrolyte fluid. In some variations, the bis(fluoromethanesulfonyl) imide can be at least 0.10 wt % of the electrolyte fluid. In some variations, the bis(fluoromethanesulfonyl) imide can be at least 0.25 wt % of the electrolyte fluid. In some variations, the bis(fluoromethanesulfonyl) imide can be at least 0.50 wt % of the electrolyte fluid. In some variations, the bis(fluoromethanesulfonyl) imide can be at least 0.75 wt % of the electrolyte fluid. In some variations, the bis(fluoromethanesulfonyl) imide can be at least 1.0 wt % of the electrolyte fluid. In some variations, the bis(fluoromethanesulfonyl) imide can be at least 1.25 wt % of the electrolyte fluid. In some variations, the bis(fluoromethanesulfonyl) imide can be at least 1.50 wt % of the electrolyte fluid. In some variations, the bis(fluoromethanesulfonyl) imide can be at least 1.75 wt % of the electrolyte fluid. In some variations, the bis(fluoromethanesulfonyl) imide can be at least 2.0 wt % of the electrolyte fluid. In some variations, the bis(fluoromethanesulfonyl) imide can be at least 2.25 wt % of the electrolyte fluid. In some variations, the bis(fluoromethanesulfonyl) imide can be at least 2.50 wt % of the electrolyte fluid. In some variations, the bis(fluoromethanesulfonyl) imide can be at least 2.75 wt % of the electrolyte fluid.

In some variations, the bis(fluoromethanesulfonyl) imide can be equal to or less than 3.00 wt % of the electrolyte fluid. In some variations, the bis(fluoromethanesulfonyl) imide can be equal to or less than 2.75 wt % of the electrolyte fluid. In some variations, the bis(fluoromethanesulfonyl) imide can be equal to or less than 2.50 wt % of the electrolyte fluid. In some variations, the bis(fluoromethanesulfonyl) imide can be equal to or less than 2.25 wt % of the electrolyte fluid. In some variations, the bis(fluoromethanesulfonyl) imide can be equal to or less than 2.00 wt % of the electrolyte fluid. In some variations, the bis(fluoromethanesulfonyl) imide can be equal to or less than 1.75 wt % of the electrolyte fluid. In some variations, the bis(fluoromethanesulfonyl) imide can be equal to or less than 1.50 wt % of the electrolyte fluid. In some variations, the bis(fluoromethanesulfonyl) imide can be equal to or less than 1.25 wt % of the electrolyte fluid. In some variations, the bis(fluoromethanesulfonyl) imide can be equal to or less than 1.00 wt % of the electrolyte fluid. In some variations, the bis(fluoromethanesulfonyl) imide can be equal to or less than 0.75 wt % of the electrolyte fluid. In some variations, the bis(fluoromethanesulfonyl) imide can be equal to or less than 0.50 wt % of the electrolyte fluid.

The bis(fluoromethanesulfonyl) imide can be present in a lower amount, upper boundary, or both. The upper and lower amounts of bis(fluoromethanesulfonyl) imide quantity as described herein can be chosen in any combination.

In some variations, the electrolyte fluid can include LiBF₄. In some variations, the amount of LiBF₄ is at least 0.01 wt % of the total electrolyte fluid. In some variations, the amount of LiBF₄ is at least 0.05 wt % of the total electrolyte fluid. In some variations, the amount of LiBF₄ is at least 0.10 wt % of the total electrolyte fluid. In some variations, the amount of LiBF₄ is at least 0.20 wt % of the total electrolyte fluid. In some variations, the amount of LiBF₄ is at least 0.25 wt % of the total electrolyte fluid. In some variations, the amount of LiBF₄ is at least 0.30 wt % of the total electrolyte fluid. In some variations, the amount of LiBF₄ is at least 0.35 wt % of the total electrolyte fluid. In some variations, the amount of LiBF₄ is at least 0.40 wt % of the total electrolyte fluid. In some variations, the amount of LiBF₄ is at least 0.45 wt % of the total electrolyte fluid. In some variations, the amount of LiBF₄ is less than or equal to 0.50 wt % of the total electrolyte fluid. In some variations, the amount of LiBF₄ is less than or equal to 0.40 wt % of the total electrolyte fluid. In some variations, the amount of LiBF₄ is less than or equal to 0.30 wt % of the total electrolyte fluid. In some variations, the amount of LiBF₄ is less than or equal to 0.25 wt % of the total electrolyte fluid. In some variations, the amount of LiBF₄ is less than or equal to 0.20 wt % of the total electrolyte fluid. In some variations, the amount of LiBF₄ is less than or equal to 0.15 wt % of the total electrolyte fluid. In some variations, the amount of LiBF₄ is less than or equal to 0.10 wt % of the total electrolyte fluid.

The electrolyte fluid can include a solvent. The solvent may be any solvent suitable for battery cells. Non-limiting examples of the solvents include propylene carbonate (PC), ethylene carbonate (EC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), and butyl acetate (BA), or combinations thereof.

The electrolyte fluid also has one or more electrolyte salts dissolved therein. The salt may be any type of salt suitable for battery cells. For example, and without limitation, salts for a lithium-ion battery cell include LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and any combinations thereof. Other salts are possible, including combinations of salts.

In some variations, the salt is at least 0.1 M in the total electrolyte fluid. In some variations, the salt is at least 0.2 M in the total electrolyte fluid. In some variations, the salt is at least 0.3 M in the total electrolyte fluid. In some variations, the salt is at least 0.4 M in the total electrolyte fluid. In some variations, the salt is at least 0.5 M in the total electrolyte fluid. In some variations, the salt is at least 0.6 M in the total electrolyte fluid. In some variations, the salt is at least 0.7 M in the total electrolyte fluid. In some variations, the salt is at least 0.8 M in the total electrolyte fluid. In some variations, the salt is at least 0.9 M in the total electrolyte fluid. In some variations, the salt is at least 1.0 M in the total electrolyte fluid. In some variations, the salt is at least 1.3 M in the total electrolyte fluid. In some variations, the salt is at least 1.6 M in the total electrolyte fluid. In some variations, the salt is at least 1.9 M in the total electrolyte fluid.

In some variations, the salt is less than or equal to 2.0 M in the electrolyte fluid. In some variations, the salt is less than or equal to 1.9 M in the electrolyte fluid. In some variations, the salt is less than or equal to 1.6 M in the electrolyte fluid. In some variations, the salt is less than or equal to 1.3 M in the electrolyte fluid. In some variations, the salt is less than or equal to 1.1 M in the electrolyte fluid. In some variations, the salt is less than or equal to 1.0 M in the electrolyte fluid. In some variations, the salt is less than or equal to 0.9 M in the electrolyte fluid. In some variations, the salt is less than or equal to 0.8 M in the electrolyte fluid. In some variations, the salt is less than or equal to 0.7 M in the electrolyte fluid. In some variations, the salt is less than or equal to 0.6 M in the electrolyte fluid. In some variations, the salt is less than or equal to 0.5 M in the electrolyte fluid. In some variations, the salt is less than or equal to 0.4 M in the electrolyte fluid. In some variations, the salt is less than or equal to 0.3 M in the electrolyte fluid. In some variations, the salt is less than or equal to 0.2 M in the electrolyte fluid.

In further variations, the electrolyte fluid can include additional additives. In non-limitign variations, the additives can include fluoroethylene carbonate (FEC), methylene methanedisulfonate (MMDS), pro-1-ene-1,3-sultone (PES), propane sultone (PS), lithium difluoro (oxalato) borate (LiDFOB), succinonitrile (SN), 1,3,6-hexanetricarbonitrile (HTCN), and any combination thereof.

In some variations, the electrolyte fluid can include FEC. In some variations, the amount of FEC is at least 0.5 wt % of the total electrolyte fluid. In some variations, the amount of FEC is at least 1.5 wt % of the total electrolyte fluid. In some variations, the amount of FEC is at least 2.0 wt % of the total electrolyte fluid. In some variations, the amount of FEC is at least 2.5 wt % of the total electrolyte fluid. In some variations, the amount of FEC is at least 3.0 wt % of the total electrolyte fluid. In some variations, the amount of FEC is at least 3.5 wt % of the total electrolyte fluid. In some variations, the amount of FEC is at least 4.0 wt % of the total electrolyte fluid. In some variations, the amount of FEC is at least 4.5 wt % of the total electrolyte fluid. In some variations, the amount of FEC is at least 5.0 wt % of the total electrolyte fluid. In some variations, the amount of FEC is at least 5.5 wt % of the total electrolyte fluid. In some variations, the amount of FEC is at least 6.5 wt % of the total electrolyte fluid. In some variations, the amount of FEC is at least 7.0 wt % of the total electrolyte fluid. In some variations, the amount of FEC is at least 7.5 wt % of the total electrolyte fluid. In some variations, the amount of FEC is at least 8.0 wt % of the total electrolyte fluid. In some variations, the amount of FEC is at least 8.5 wt % of the total electrolyte fluid. In some variations, the amount of FEC is at least 9.0 wt % of the total electrolyte fluid. In some variations, the amount of FEC is at least 9.5 wt % of the total electrolyte fluid. In some variations, the amount of FEC is at least 10.0 wt % of the total electrolyte fluid. In some variations, the amount of FEC is at least 10.5 wt % of the total electrolyte fluid. In some variations, the amount of FEC is at least 11.0 wt % of the total electrolyte fluid. In some variations, the amount of FEC is at least 11.5 wt % of the total electrolyte fluid. In some variations, the amount of FEC is at least 11.0 wt % of the total electrolyte fluid. In some variations, the amount of FEC is at least 11.5 wt % of the total electrolyte fluid. In some variations, the amount of FEC is at least 12.0 wt % of the total electrolyte fluid. In some variations, the amount of FEC is at least 12.5 wt % of the total electrolyte fluid. In some variations, the amount of FEC is at least 13.0 wt % of the total electrolyte fluid. In some variations, the amount of FEC is at least 13.5 wt % of the total electrolyte fluid. In some variations, the amount of FEC is at least 14.0 wt % of the total electrolyte fluid. In some variations, the amount of FEC is at least 14.5 wt % of the total electrolyte fluid. In some variations, the amount of FEC is at least 15.0 wt % of the total electrolyte fluid. In some variations, the amount of FEC is at least 15.5 wt % of the total electrolyte fluid. In some variations, the amount of FEC is at least 16.0 wt % of the total electrolyte fluid. In some variations, the amount of FEC is at least 16.5 wt % of the total electrolyte fluid. In some variations, the amount of FEC is at least 17.0 wt % of the total electrolyte fluid. In some variations, the amount of FEC is at least 17.5 wt % of the total electrolyte fluid. In some variations, the amount of FEC is at least 18.0 wt % of the total electrolyte fluid. In some variations, the amount of FEC is at least 18.5 wt % of the total electrolyte fluid. In some variations, the amount of FEC is at least 19.0 wt % of the total electrolyte fluid. In some variations, the amount of FEC is at least 19.5 wt % of the total electrolyte fluid. In some variations, the amount of FEC is at least 20 wt % of the total electrolyte fluid. In some variations, the amount of FEC is at least 20.5 wt % of the total electrolyte fluid. In some variations, the amount of FEC is at least 21.0 wt % of the total electrolyte fluid. In some variations, the amount of FEC is at least 21.5 wt % of the total electrolyte fluid. In some variations, the amount of FEC is at least 22.0 wt % of the total electrolyte fluid. In some variations, the amount of FEC is at least 22.5 wt % of the total electrolyte fluid. In some variations, the amount of FEC is at least 23.0 wt % of the total electrolyte fluid. In some variations, the amount of FEC is at least 23.5 wt % of the total electrolyte fluid. In some variations, the amount of FEC is at least 24.0 wt % of the total electrolyte fluid. In some variations, the amount of FEC is at least 24.5 wt % of the total electrolyte fluid.

In some variations, the amount of FEC is less than or equal to 25.0 wt % of the total electrolyte fluid. In some variations, the amount of FEC is less than or equal to 24.5 wt % of the total electrolyte fluid. In some variations, the amount of FEC is less than or equal to 24.0 wt % of the total electrolyte fluid. In some variations, the amount of FEC is less than or equal to 23.5 wt % of the total electrolyte fluid. In some variations, the amount of FEC is less than or equal to 23.0 wt % of the total electrolyte fluid. In some variations, the amount of FEC is less than or equal to 22.5 wt % of the total electrolyte fluid. In some variations, the amount of FEC is less than or equal to 22.0 wt % of the total electrolyte fluid. In some variations, the amount of FEC is less than or equal to 21.5 wt % of the total electrolyte fluid. In some variations, the amount of FEC is less than or equal to 21.0 wt % of the total electrolyte fluid. In some variations, the amount of FEC is less than or equal to 20.5 wt % of the total electrolyte fluid. In some variations, the amount of FEC is less than or equal to 20.0 wt % of the total electrolyte fluid. In some variations, the amount of FEC is less than or equal to 19.5 wt % of the total electrolyte fluid. In some variations, the amount of FEC is less than or equal to 19.0 wt % of the total electrolyte fluid. In some variations, the amount of FEC is less than or equal to 18.5 wt % of the total electrolyte fluid. In some variations, the amount of FEC is less than or equal to 18.0 wt % of the total electrolyte fluid. In some variations, the amount of FEC is less than or equal to 17.5 wt % of the total electrolyte fluid. In some variations, the amount of FEC is less than or equal to 17.0 wt % of the total electrolyte fluid. In some variations, the amount of FEC is less than or equal to 16.5 wt % of the total electrolyte fluid. In some variations, the amount of FEC is less than or equal to 16.0 wt % of the total electrolyte fluid. In some variations, the amount of FEC is less than or equal to 15.5 wt % of the total electrolyte fluid. In some variations, the amount of FEC is less than or equal to 15.0 wt % of the total electrolyte fluid. In some variations, the amount of FEC is less than or equal to 14.5 wt % of the total electrolyte fluid. In some variations, the amount of FEC is less than or equal to 14.0 wt % of the total electrolyte fluid. In some variations, the amount of FEC is less than or equal to 13.5 wt % of the total electrolyte fluid. In some variations, the amount of FEC is less than or equal to 13.0 wt % of the total electrolyte fluid. In some variations, the amount of FEC is less than or equal to 12.5 wt % of the total electrolyte fluid. In some variations, the amount of FEC is less than or equal to 12.0 wt % of the total electrolyte fluid. In some variations, the amount of FEC is less than or equal to 11.5 wt % of the total electrolyte fluid. In some variations, the amount of FEC is less than or equal to 11.0 wt % of the total electrolyte fluid. In some variations, the amount of FEC is less than or equal to 10.5 wt % of the total electrolyte fluid. In some variations, the amount of FEC is less than or equal to 10.0 wt % of the total electrolyte fluid. In some variations, the amount of FEC is less than or equal to 9.5 wt % of the total electrolyte fluid. In some variations, the amount of FEC is less than or equal to 9.0 wt % of the total electrolyte fluid. In some variations, the amount of FEC is less than or equal to 8.5 wt % of the total electrolyte fluid. In some variations, the amount of FEC is less than or equal to 8.0 wt % of the total electrolyte fluid. In some variations, the amount of FEC is less than or equal to 7.5 wt % of the total electrolyte fluid. In some variations, the amount of FEC is less than or equal to 7.0 wt % of the total electrolyte fluid. In some variations, the amount of FEC is less than or equal to 6.5 wt % of the total electrolyte fluid. In some variations, the amount of FEC is less than or equal to 6.0 wt % of the total electrolyte fluid. In some variations, the amount of FEC is less than or equal to 5.5 wt % of the total electrolyte fluid. In some variations, the amount of FEC is less than or equal to 5.0 wt % of the total electrolyte fluid. In some variations, the amount of FEC is less than or equal to 4.5 wt % of the total electrolyte fluid. In some variations, the amount of FEC is less than or equal to 4.0 wt % of the total electrolyte fluid. In some variations, the amount of FEC is less than or equal to 3.5 wt % of the total electrolyte fluid. In some variations, the amount of FEC is less than or equal to 3.0 wt % of the total electrolyte fluid. In some variations, the amount of FEC is less than or equal to 2.5 wt % of the total electrolyte fluid. In some variations, the amount of FEC is less than or equal to 2.0 wt % of the total electrolyte fluid. In some variations, the amount of FEC is less than or equal to 1.5 wt % of the total electrolyte fluid. In some variations, the amount of FEC is less than or equal to 1.0 wt % of the total electrolyte fluid.

FEC can be present in a lower boundary, upper boundary, or both. The upper and lower boundaries of the FEC quantity as described herein can be chosen in any combination.

In some variations, the amount of MMDS is at least 0.1 wt % of the total electrolyte fluid. In some variations, the amount of MMDS is at least 0.5 wt % of the total electrolyte fluid. In some variations, the amount of MMDS is at least 1.0 wt % of the total electrolyte fluid. In some variations, the amount of MMDS is at least 1.5 wt % of the total electrolyte fluid. In some variations, the amount of MMDS is at least 2.0 wt % of the total electrolyte fluid. In some variations, the amount of MMDS is at least 2.5 wt % of the total electrolyte fluid. In some variations, the amount of MMDS is at least 3.0 wt % of the total electrolyte fluid. In some variations, the amount of MMDS is at least 3.5 wt % of the total electrolyte fluid. In some variations, the amount of MMDS is at least 4.0 wt % of the total electrolyte fluid. In some variations, the amount of MMDS is at least 4.5 wt % of the total electrolyte fluid.

In some variations, the amount of MMDS is less than or equal to 5.0 wt % of the total electrolyte fluid. In some variations, the amount of MMDS is less than or equal to 4.5 wt % of the total electrolyte fluid. In some variations, the amount of MMDS is less than or equal to 4.0 wt % of the total electrolyte fluid. In some variations, the amount of MMDS is less than or equal to 3.5 wt % of the total electrolyte fluid. In some variations, the amount of MMDS is less than or equal to 3.0 wt % of the total electrolyte fluid. In some variations, the amount of MMDS is less than or equal to 2.5 wt % of the total electrolyte fluid. In some variations, the amount of MMDS is less than or equal to 2.0 wt % of the total electrolyte fluid. In some variations, the amount of MMDS is less than or equal to 1.5 wt % of the total electrolyte fluid. In some variations, the amount of MMDS is less than or equal to 1.0 wt % of the total electrolyte fluid. In some variations, the amount of MMDS is less than or equal to 0.5 wt % of the total electrolyte fluid.

MMDS can be present in a lower boundary, upper boundary, or both. The upper and lower boundaries of the MMDS quantity as described herein can be chosen in any combination.

In some variations, the electrolyte fluid can include LiDFOB. LiDFOB is at least 0.1 wt % of the total electrolyte fluid. In some variations, LiDFOB is at least 0.2 wt % of the total electrolyte fluid. In some variations, LiDFOB is at least 0.3 wt % of the total electrolyte fluid. In some variations, LiDFOB is at least 0.4 wt % of the total electrolyte fluid. In some variations, LIDFOB is at least 0.5 wt % of the total electrolyte fluid. In some variations, LiDFOB is at least 0.6 wt % of the total electrolyte fluid. In some variations, LiDFOB is at least 0.7 wt % of the total electrolyte fluid. In some variations, LiDFOB is at least 0.8 wt % of the total electrolyte fluid. In some variations, LiDFOB is at least 0.9 wt % of the total electrolyte fluid. In some variations, LiDFOB is at least 1.0 wt % of the total electrolyte fluid. In some variations, LiDFOB is at least 1.3 wt % of the total electrolyte fluid. In some variations, LiDFOB is at least 1.6 wt % of the total electrolyte fluid. In some variations, LiDFOB is at least 1.9 wt % of the total electrolyte fluid. In some variations, LiDFOB is at least 2.0 wt % of the total electrolyte fluid. In some variations, LiDFOB is at least 2.3 wt % of the total electrolyte fluid. In some variations, LiDFOB is at least 2.6 wt % of the total electrolyte fluid. In some variations, LiDFOB is at least 2.9 wt % of the total electrolyte fluid.

In some variations, LiDFOB is less than or equal to 3.0 wt % of the total electrolyte fluid. In some variations, LiDFOB is less than or equal to 2.9 wt % of the total electrolyte fluid. In some variations, LiDFOB is less than or equal to 2.6 wt % of the total electrolyte fluid. In some variations, LiDFOB is less than or equal to 2.3 wt % of the total electrolyte fluid. In some variations, LiDFOB is less than or equal to 2.0 wt % of the total electrolyte fluid. In some variations, LiDFOB is less than or equal to 1.9 wt % of the total electrolyte fluid. In some variations, LiDFOB is less than or equal to 1.3 wt % of the total electrolyte fluid. In some variations, LiDFOB is less than or equal to 1.3 wt % of the total electrolyte fluid. In some variations, LiDFOB is less than or equal to 1.1 wt % of the total electrolyte fluid. In some variations, LiDFOB is less than or equal to 1.0 wt % of the total electrolyte fluid. In some variations, LiDFOB is less than or equal to 0.9 wt % of the total electrolyte fluid. In some variations, LiDFOB is less than or equal to 0.8 wt % of the total electrolyte fluid. In some variations, LiDFOB is less than or equal to 0.7 wt % of the total electrolyte fluid. In some variations, LiDFOB is less than or equal to 0.6 wt % of the total electrolyte fluid. In some variations, LiDFOB is less than or equal to 0.5 wt % of the total electrolyte fluid. In some variations, LiDFOB is less than or equal to 0.4 wt % of the total electrolyte fluid. In some variations, LiDFOB is less than or equal to 0.3 wt % of the total electrolyte fluid. In some variations, LiDFOB is less than or equal to 0.2 wt % of the total electrolyte fluid.

In some variations, the amount of PES is at least 0.1 wt % of the total electrolyte fluid. In some variations, the amount of PES is at least 0.2 wt % of the total electrolyte fluid. In some variations, the amount of PES is at least 0.3 wt % of the total electrolyte fluid. In some variations, the amount of PES is at least 0.4 wt % of the total electrolyte fluid. In some variations, the amount of PES is at least 0.5 wt % of the total electrolyte fluid. In some variations, the amount of PES is at least 1.0 wt % of the total electrolyte fluid. In some variations, the amount of PES is at least 1.5 wt % of the total electrolyte fluid. In some variations, the amount of PES is at least 2.0 wt % of the total electrolyte fluid. In some variations, the amount of PES is at least 2.5 wt % of the total electrolyte fluid. In some variations, the amount of PES is at least 3.0 wt % of the total electrolyte fluid. In some variations, the amount of PES is at least 3.5 wt % of the total electrolyte fluid. In some variations, the amount of PES is at least 4.0 wt % of the total electrolyte fluid. In some variations, the amount of PES is at least 4.5 wt % of the total electrolyte fluid. In some variations, the amount of PES is at least 5.0 wt % of the total electrolyte fluid.

In some variations, the amount of PES is less than or equal to 6.0 wt % of the total electrolyte fluid. In some variations, the amount of PES is less than or equal to 5.5 wt % of the total electrolyte fluid. In some variations, the amount of PES is less than or equal to 5.0 wt % of the total electrolyte fluid. In some variations, the amount of PES is less than or equal to 4.5 wt % of the total electrolyte fluid. In some variations, the amount of PES is less than or equal to 4.0 wt % of the total electrolyte fluid. In some variations, the amount of PES is less than or equal to 3.5 wt % of the total electrolyte fluid. In some variations, the amount of PES is less than or equal to 3.0 wt % of the total electrolyte fluid. In some variations, the amount of PES is less than or equal to 2.5 wt % of the total electrolyte fluid. In some variations, the amount of PES is less than or equal to 2.0 wt % of the total electrolyte fluid. In some variations, the amount of PES is less than or equal to 1.5 wt % of the total electrolyte fluid. In some variations, the amount of PES is less than or equal to 1.0 wt % of the total electrolyte fluid.

In some variations, the amount of PS is at least 0.5 wt % of the total electrolyte fluid. In some variations, the amount of PS is at least 1.0 wt % of the total electrolyte fluid. In some variations, the amount of PS is at least 1.5 wt % of the total electrolyte fluid. In some variations, the amount of PS is at least 2.0 wt % of the total electrolyte fluid. In some variations, the amount of PS is at least 2.5 wt % of the total electrolyte fluid. In some variations, the amount of PS is at least 3.0 wt % of the total electrolyte fluid. In some variations, the amount of PS is at least 3.5 wt % of the total electrolyte fluid. In some variations, the amount of PS is at least 4.0 wt % of the total electrolyte fluid. In some variations, the amount of PS is at least 4.5 wt % of the total electrolyte fluid. In some variations, the amount of PS is at least 5.0 wt % of the total electrolyte fluid. In some variations, the amount of PS is at least 5.5 wt % of the total electrolyte fluid.

In some variations, the amount of PS is at least 6.0 wt % of the total electrolyte fluid.

In some variations, the amount of PS is at least 6.5 wt % of the total electrolyte fluid.

In some variations, the amount of PS is at least 7.0 wt % of the total electrolyte fluid.

In some variations, the amount of PS is at least 7.5 wt % of the total electrolyte fluid.

In some variations, the amount of PS is at least 8.0 wt % of the total electrolyte fluid.

In some variations, the amount of PS is at least 8.5 wt % of the total electrolyte fluid.

In some variations, the amount of PS is at least 9.0 wt % of the total electrolyte fluid.

In some variations, the amount of PS is at least 9.5 wt % of the total electrolyte fluid.

In some variations, the amount of PS is less than or equal to 10.0 wt % of the total electrolyte fluid. In some variations, the amount of PS is less than or equal to 9.5 wt % of the total electrolyte fluid. In some variations, the amount of PS is less than or equal to 9.0 wt % of the total electrolyte fluid. In some variations, the amount of PS is less than or equal to 8.5 wt % of the total electrolyte fluid. In some variations, the amount of PS is less than or equal to 8.0 wt % of the total electrolyte fluid. In some variations, the amount of PS is less than or equal to 7.5 wt % of the total electrolyte fluid. In some variations, the amount of PS is less than or equal to 7.0 wt % of the total electrolyte fluid. In some variations, the amount of PS is less than or equal to 6.5 wt % of the total electrolyte fluid. In some variations, the amount of PS is less than or equal to 6.0 wt % of the total electrolyte fluid. In some variations, the amount of PS is less than or equal to 5.5 wt % of the total electrolyte fluid. In some variations, the amount of PS is less than or equal to 5.0 wt % of the total electrolyte fluid. In some variations, the amount of PS is less than or equal to 4.5 wt % of the total electrolyte fluid. In some variations, the amount of PS is less than or equal to 4.0 wt % of the total electrolyte fluid. In some variations, the amount of PS is less than or equal to 3.5 wt % of the total electrolyte fluid. In some variations, the amount of PS is less than or equal to 3.0 wt % of the total electrolyte fluid. In some variations, the amount of PS is less than or equal to 2.5 wt % of the total electrolyte fluid. In some variations, the amount of PS is less than or equal to 2.0 wt % of the total electrolyte fluid. In some variations, the amount of PS is less than or equal to 1.5 wt % of the total electrolyte fluid. In some variations, the amount of PS is less than or equal to 1.0 wt % of the total electrolyte fluid.

In some variations, the amount of SN is at least 0.5 wt % of the total electrolyte fluid. In some variations, the amount of SN is at least 1.0 wt % of the total electrolyte fluid. In some variations, the amount of SN is at least 1.5 wt % of the total electrolyte fluid. In some variations, the amount of SN is at least 2.0 wt % of the total electrolyte fluid. In some variations, the amount of SN is at least 2.5 wt % of the total electrolyte fluid. In some variations, the amount of SN is at least 3.0 wt % of the total electrolyte fluid. In some variations, the amount of SN is at least 3.5 wt % of the total electrolyte fluid. In some variations, the amount of SN is at least 4.0 wt % of the total electrolyte fluid. In some variations, the amount of SN is at least 4.5 wt % of the total electrolyte fluid. In some variations, the amount of SN is at least 5.0 wt % of the total electrolyte fluid.

In some variations, the amount of SN is less than or equal to 6.0 wt % of the total electrolyte fluid. In some variations, the amount of SN is less than or equal to 5.5 wt % of the total electrolyte fluid. In some variations, the amount of SN is less than or equal to 5.0 wt % of the total electrolyte fluid. In some variations, the amount of SN is less than or equal to 4.5 wt % of the total electrolyte fluid. In some variations, the amount of SN is less than or equal to 4.0 wt % of the total electrolyte fluid. In some variations, the amount of SN is less than or equal to 3.5 wt % of the total electrolyte fluid. In some variations, the amount of SN is less than or equal to 3.0 wt % of the total electrolyte fluid. In some variations, the amount of SN is less than or equal to 2.5 wt % of the total electrolyte fluid. In some variations, the amount of SN is less than or equal to 2.0 wt % of the total electrolyte fluid. In some variations, the amount of SN is less than or equal to 1.5 wt % of the total electrolyte fluid. In some variations, the amount of SN is less than or equal to 1.0 wt % of the total electrolyte fluid.

In some variations, the amount of HTCN is at least 0.5 wt % of the total electrolyte fluid. In some variations, the amount of HTCN is at least 1.0 wt % of the total electrolyte fluid. In some variations, the amount of HTCN is at least 1.5 wt % of the total electrolyte fluid. In some variations, the amount of HTCN is at least 2.0 wt % of the total electrolyte fluid. In some variations, the amount of HTCN is at least 2.5 wt % of the total electrolyte fluid. In some variations, the amount of HTCN is at least 3.0 wt % of the total electrolyte fluid. In some variations, the amount of HTCN is at least 3.5 wt % of the total electrolyte fluid. In some variations, the amount of HTCN is at least 4.0 wt % of the total electrolyte fluid. In some variations, the amount of HTCN is at least 4.5 wt % of the total electrolyte fluid. In some variations, the amount of HTCN is at least 5.0 wt % of the total electrolyte fluid.

In some variations, the amount of HTCN is less than or equal to 6.0 wt % of the total electrolyte fluid. In some variations, the amount of HTCN is less than or equal to 5.5 wt % of the total electrolyte fluid. In some variations, the amount of HTCN is less than or equal to 5.0 wt % of the total electrolyte fluid. In some variations, the amount of HTCN is less than or equal to 4.5 wt % of the total electrolyte fluid. In some variations, the amount of HTCN is less than or equal to 4.0 wt % of the total electrolyte fluid. In some variations, the amount of HTCN is less than or equal to 3.5 wt % of the total electrolyte fluid. In some variations, the amount of HTCN is less than or equal to 3.0 wt % of the total electrolyte fluid. In some variations, the amount of HTCN is less than or equal to 2.5 wt % of the total electrolyte fluid. In some variations, the amount of HTCN is less than or equal to 2.0 wt % of the total electrolyte fluid. In some variations, the amount of HTCN is less than or equal to 1.5 wt % of the total electrolyte fluid. In some variations, the amount of HTCN is less than or equal to 1.0 wt % of the total electrolyte fluid.

### EXAMPLES

The Examples are provided for illustration purposes only. These examples are not intended to constrain any embodiment disclosed herein to any application or theory of operation.

### Example 1

Table 1 shows a series of electrolyte compositions.

TABLE 1

| Electrolyte | Salt and | Additives wt % | | | | | | | | |
|---|---|---|---|---|---|---|---|---|---|---|
| Fluid Number | Solvent | LiDFOB | PS | PES | MMDS | LiTFSI | FEC | LiBF₄ | SN | HTCN |
| 1 | 1.2M | 0.7 | 2.5 | 1.5 | 0.5 | 0 | 7 | 0 | 2 | 3 |
| 2 | LiPF₆ | 0.7 | 2.5 | 1.5 | 0.5 | 0 | 7 | 0.2 | 2 | 3 |
| 3 | EC/PC/ | 0.7 | 2.5 | 1.5 | 0.5 | 0.3 | 7 | 0.2 | 2 | 3 |
| | PP/EP = | | | | | | | | | |
| | 20/10/ | | | | | | | | | |
| | 25/45 | | | | | | | | | |

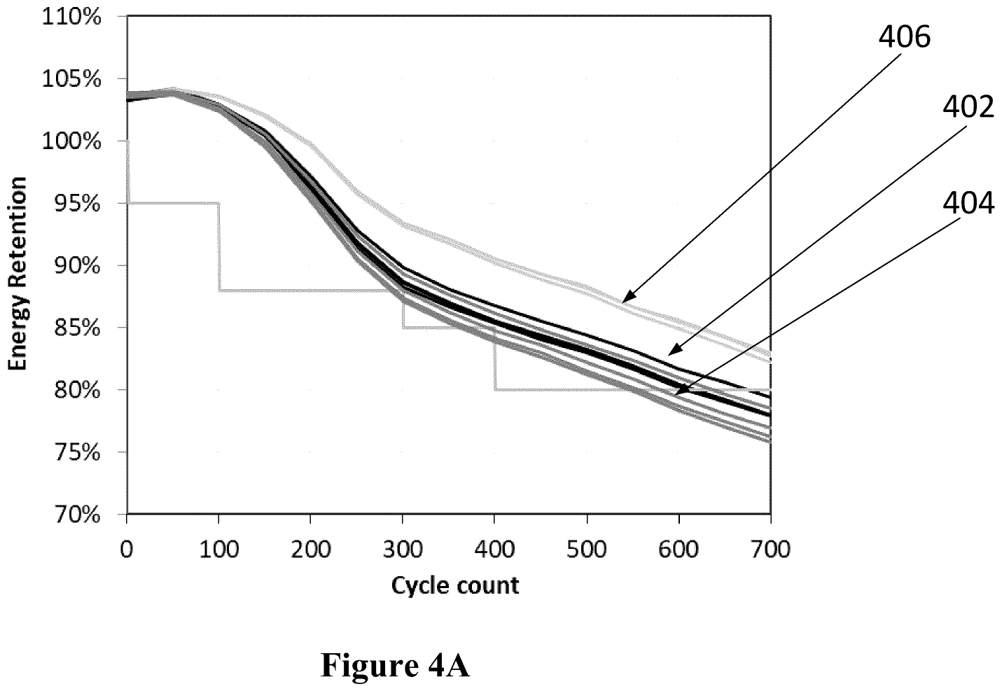

FIGS. 3A and 3B depicts cyclic voltammogram using a 5 mV/second scan rate of a battery cell showing the effect of Electrolyte Fluid 1 with and without LiTFSI. The working electrode is a standard plasma electrode. FIG. 3A depicts the first cycle 302, second cycle 304, and third cycle 306 without 0.3 wt % LiTFSI. By comparison, FIG. 3B depicts the first cycle 308, second cycle 310, and third cycle 312 with 0.3 wt % LiTFSI.

With respect to FIG. 3B, the first cycle 308 results in decomposition of the LiTFSI. The lower on-set potential in the battery cell with the electrolyte fluid containing LiTFSI as compared to the electrolyte fluid without LiTFSI suggested that LiTFSI was oxidized and decomposed before other components.

As further depicted in FIG. 3B, the second cycle 310 and third cycle 312 of the battery cell with the electrolyte fluid including LiTFSI had a lower oxidative current than the second cycle 304 and third cycle 306 depicted in FIG. 3A of the battery cell with an electrolyte fluid lacking LiTFSI. The lower oxidative current of FIG. 3B suggests an oxidative reaction and passivation of the cathode in the battery cell with the LiTFSI-containing electrolyte fluid during the oxidation process.

### Example 2

Pouch swelling was measured in an MLP battery cell at 85° C. and 60° C., at 4.50V. Three Electrolyte Fluids were tested: Electrolyte Fluid 1, Electrolyte Fluid 2 that included 0.2 wt % LiBF₄, and Electrolyte Fluid 3 that included both 0.2 wt % LiBF₄ and 0.3 wt % LiTFSI. As depicted in Table 2, the addition of each of the LiBF₄ (Electrolyte Fluid 2), and LiBF₄ and LiTFSI (Electrolyte Fluid 3) resulted in reduced swelling as a percentage of volume. Higher temperature resulted in greater swelling due to increased degradation of electrolyte fluid components.

TABLE 2

| | Electrolyte 1 | Electrolyte 2 | Electrolyte 3 |
|---|---|---|---|
| 85° C. swell | 4.232 +/− 0.015 | 4.167 +/− 0.021 | 4.193 +/− 0.025 |
| (mm) | | | |
| 85° C. swell | 4.21 +/− 0.85 | 2.54 +/− 0.41 | 2.13 +/− 0.84 |
| (%) | | | |
| 85° C. | 93.30 +/− 0.70 | 94.14 +/− 0.26 | 93.94 +/− 0.90 |
| recovery | | | |
| capacity (%) | | | |
| 60° C. swell | 4.108 +/− 0.011 | 4.077 +/− 0.005 | 4.105 +/− 0.015 |
| (mm) | | | |
| 60° C. swell | 1.50 +/− 0.18 | 0.77 +/− 0.13 | 0.45 +/− 0.24 |
| (%) | | | |
| 60° C. | 89.29 +/− 0.42 | 90.05 +/− 0.37 | 90.03 +/− 0.34 |
| recovery | | | |
| capacity (%) | | | |

### Example 3

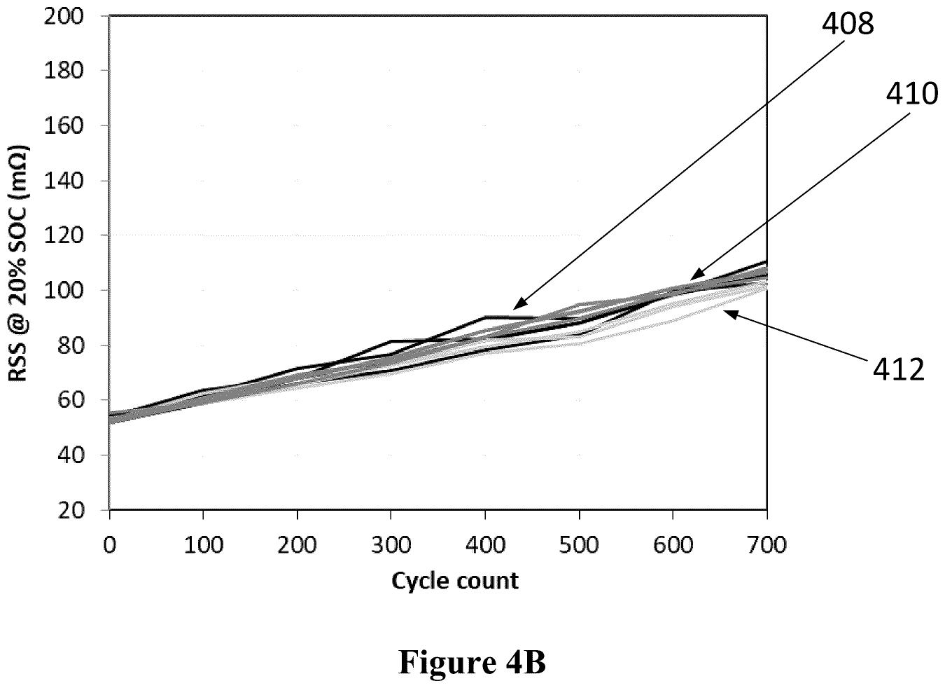

FIGS. 4A and 4B depict energy retention and internal resistance, respectively, each as a function of cycle count for battery cells in a MLP containing Electrolyte Fluids 1, 2, or 3 at 45° C. and 4.5V. FIG. 4B depicts internal resistance as a function of cycle count for battery cells in a MLP containing Electrolyte Fluids 1, 2, or 3 at 45° C. and 4.5V.

Battery cells containing Electrolyte Fluid 3 (406), which included both 0.2 wt % LiBF₄ and 0.3 wt % LiTFSI, showed higher energy retention as a function of cycle count over 700 cycles than Electrolyte Fluid 1 (402) and Electrolyte Fluid 2 (404).

Likewise, with respect to FIG. 4B, battery cells containing Electrolyte Fluid 3 (412), which included both 0.2 wt % LiBF₄ and 0.3 wt % LiTFSI, showed lower internal resistance RSS as a function of cycle count over 700 cycles than Electrolyte Fluid 1 (408) and Electrolyte Fluid 2 (410).

The electrolyte fluids described herein can be valuable in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A battery cell comprising:
a cathode comprising a cathode active material disposed on a cathode current collector;
an anode comprising an anode active material disposed on an anode current collector, the anode oriented towards the cathode such that the anode active material faces the cathode active material;
a separator disposed between the cathode active material and the anode active material; and
an electrolyte fluid disposed between the cathode and the anode, the electrolyte fluid comprising a lithium bis(fluoromethanesulfonyl) imide selected from lithium bis(trifluoromethanesulfonyl)imide (LiTFSI), lithium bis(difluoromethanesulfonyl) imide (LiDFSI), and lithium bis(monofluoromethanesulfonyl)imide (LiMFSI).

2. The battery cell of claim 1, wherein the lithium bis(fluoromethanesulfonyl) imide is LiTFSI.

3. The battery cell of claim 1, wherein the lithium bis(fluoromethanesulfonyl) imide is LiDFSI.

4. The battery cell of claim 1, wherein the lithium bis(fluoromethanesulfonyl) imide is LiMFSI.

5. The battery cell of claim 1, wherein the lithium bis(fluoromethanesulfonyl) imide is in an amount of 0.05 wt %-3.0 wt % of the electrolyte fluid.

6. The battery cell of claim 1, comprising LiBF₄.

7. The battery cell of claim 6, wherein the LiBF₄ is in an amount of 0.01 wt %-0.50 wt % of the electrolyte fluid.

8. The battery cell of claim 2, comprising LiBF₄.

9. The battery cell of claim 1, comprising a salt selected from LiPF₆, LiBF₄, LiClO₄, LiSO₃CF₃, LiN(SO₂F)₂, LiN(SO₂CF₃)₂, LiBC₄O₈, Li[PF₃(C₂CF₃)₃], LiC(SO₂CF₃)₃, and a combination thereof.

10. The battery cell of claim 9, wherein the salt comprises LiPF₆.

11. The battery cell of claim 9, wherein the salt is in an amount of 0.1 M-2.0 M in the electrolyte fluid.

12. The battery cell of claim 1, comprising a solvent selected from fluoroethylene carbonate (FEC), propylene carbonate (PC), ethylene carbonate (EC), dimethyl carbonate (DMC), diethyl carbonate (DEC), ethyl-methyl carbonate (EMC), ethyl propionate (EP), butyl butyrate (BB), methyl acetate (MA), ethyl acetate (EA), propyl propionate (PP), butyl propionate (BP), propyl acetate (PA), and butyl acetate (BA), and a combination thereof.

13. The battery cell of claim 12, wherein the solvent is selected from PC, EC, PP, EP, and a combination thereof.

14. The battery cell of claim 12, wherein the solvent comprises PC, EC, PP, and EP.

15. The battery cell of claim 1, comprising an additive selected from fluoroethylene carbonate (FEC), methylene methanedisulfonate (MMDS), pro-1-ene-1,3-sultone (PES), propane sultone (PS), lithium difluoro (oxalato) borate (LiDFOB), succinonitrile (SN), 1,3,6-hexanetricarbonitrile (HTCN), and a combination thereof.

16. The battery cell of claim 15, wherein the additive comprises 0.1 wt %-25.0 wt % FEC.

17. The battery cell of claim 15, wherein the additive comprises 0.1 wt %-5.0 wt % MMDS.

18. The battery cell of claim 15, wherein the additive comprises 0.1 wt %-3.0 wt % LiDFOB.

19. The battery cell of claim 15, wherein the additive comprises 0.5 wt %-6.0 wt % PES.

20. The battery cell of claim 15, wherein the additive comprises 0.1 wt %-10.0 wt % PS. 0.5 wt %-6.0 wt % SN, and 0.5 wt %-6.0 wt % HTCN.
